(19) United States
(12) Patent Application Publication
(10) Pub. No.: US 2007/0275230 A1
(43) Pub. Date: Nov. 29, 2007

(54) Methods and systems for creating a material with nanomaterials

(76) Inventors: Robert Murphy, Cambridge (GB); Oleksiy Rozhin, (US); Andrea C. Ferrari, (US); John Robertson, (US); William I. Milne, (US)

Correspondence Address: WILMER CUTLER PICKERING HALE AND DORR LLP, 399 PARK AVENUE, NEW YORK, NY, 10022, US

(21) Appl. No.: 11/441,496

(22) Filed: May 26, 2006

(51) Int. Cl. B32B 5/16

(52) U.S. Cl. 428/323

(57) ABSTRACT

Methods and systems for creating a material with nanomaterials attached are provided. The material used may be flexible. The material used may also be transparent. Also, the method and system disclosed may be performed at room temperature. The nanomaterials located on the material may be conductive or semi-conductive. Methods for creating the material and some general uses for the material may also be provided.

All patents, patent applications and publications cited herein are hereby incorporated by reference in their entirety. The disclosures of these publications in their entireties are hereby incorporated by reference into this application in order to more fully describe the state of the art as known to those skilled therein as of the date of the invention described and claimed herein.

This patent disclosure contains material that is subject to copyright protection. The copyright owner has no objection to the facsimile reproduction by anyone of the patent document or the patent disclosure as it appears in the U.S. Patent and Trademark Office patent file or records, but otherwise reserves any and all copyright rights.

### FIELD OF THE INVENTION

The present invention relates to methods and systems for creating a material with nanomaterials attached on the surface.

### BACKGROUND OF THE INVENTION

There are many uses for a material with a conductive surface, for example, a flexible material with a conductive surface allows the production of flexible touch screen monitors. One commonly used device with a conductive surface is a touch screen monitor which typically uses liquid crystal displays or thin film transistors. Presently, most conductive touch screens use indium tin oxide (ITO). Although ITO is reliable, it is rigid and limits the design of flexible touch screens.

Carbon nanotubes have been used to produce a flexible conductive material; however, the materials produced are not substantially transparent as is required, for example in touch screen monitors. This is in part due to the inability of previous production techniques to control carbon nanotube placement. For example, the materials previously produced had a large number of carbon nanotubes dispersed throughout the materials. As the number of carbon nanotubes increases, the transparency of the materials decrease because the carbon nanotubes interfere with light transmission.

In order for nanomaterials, such as nanotubes and nanostructures, to compete with ITO a surface electrical conductance greater than 0.001 siemens/square is required. Further, nanomaterials attached to a transparent surface must maintain a high level of transparency to visible light, for example, by transmittance greater than 80%. Ideally producing a transparent flexible material with a conductive surface will not require large production costs or a complicated procedure.

### SUMMARY OF THE INVENTION

The present invention relates to a method for producing a material with nanomaterials attached to the surface of the material. Further, the invention relates to a product comprising a material with nanomaterials attached to the surface.

In accordance with certain embodiments of the invention, initially, nanoink may be made from nanomaterials dispersed or dissolved in a solvent, and a substrate may be prepared out of any suitable organic or inorganic material, such as silicon dioxide, silicon oxide, or glass. In one specific embodiment, the substrate surface may then be treated with silane. The nanoink may then be placed on the substrate, and a material may be placed on the nanoink. The material may be for example, a polymer with a solvent or small molecules (e.g. pentacene). Preferably, the material is drop cast onto the nanoink. When desired, the user may remove the solvent in the nanoink, the material, or both, for example by baking, washing, or chemical/biological methods. When the user removes the solvent in the nanoink this leaves a nanolayer (consisting of nanomaterials). After the solvent is at least partially removed, the user may peel the material layer from the substrate. The nanomaterials adhere to the material because the work of adhesion between the nanomaterials and the material is greater than the work of adhesion between the nanomaterials and the substrate. When peeled, nanomaterials are attached to the material and the substrate is left behind. The material layer now has nanomaterials attached to the surface of the material.

In some embodiments, after removing the solvent from the nanoink, the nanolayer remains on the substrate. When desired, the user may remove the material in a similar manner as described above or may dissolve the material leaving behind the nanolayer.

The present invention includes a product comprising a material with nanomaterials attached to the surface. The material with nanomaterials attached allows conductivity and transparency on a flexible or rigid substrate. This material may be used in, for example, liquid crystal displays, thin film transistors, and car windows.

### BRIEF DESCRIPTION OF THE DRAWINGS

Various objects, features, and advantages of the present invention can be more fully appreciated with reference to the following detailed description of the invention when considered in connection with the following drawings, in which like reference numerals identify like elements:

FIG. 1A illustrates nanomaterials in a solvent on top of a substrate in accordance with certain embodiments of the present invention;

FIG. 1B illustrates nanomaterials in a solvent on top of a substrate with a housing in accordance with certain embodiments of the present invention;

FIG. 2 illustrates a material on top of nanolayer in accordance with certain embodiments of the present invention;

FIG. 3 illustrates peeling apart a material with nanomaterials attached from a substrate in accordance with certain embodiments of the present invention;

FIG. 4A illustrates a material with nanomaterials attached completely separated from a substrate in accordance with certain embodiments of the present invention;

FIG. 4B illustrates a material with nanomaterials, which is attached to a second material layer in accordance with certain embodiments of the present invention;

FIG. 5 is a general outline demonstrating how a material with nanomaterials attached is made and potential uses for it in accordance with certain embodiments of the present invention; and

FIG. 6 illustrates a use for nanomaterials attached to a material in accordance with certain embodiments of the present invention.

### DETAILED DESCRIPTION OF THE PREFERRED EMBODIMENTS

In the following description, numerous specific details are set forth regarding the systems and methods of the present invention and the environment in which such systems and methods may operate, etc., in order to provide a thorough understanding of the present invention. It will be apparent to one skilled in the art, however, that the present invention may be practiced without such specific details, and that certain features which are well known in the art are not described in detail in order to avoid complication of the subject matter of the present invention. In addition, it will be understood that the examples provided below are exemplary, and that it is contemplated that there are other methods and systems that are within the scope of the present invention.

Generally, the invention relates to adhering nanomaterials to an external surface of a transparent material. The method as illustratively disclosed may be performed at room temperature. The nanomaterials may be electrically conductive or semi-conductive. In accordance with the described examples, a substantially two-dimensional layer of nanomaterials is adhered to a transparent material.

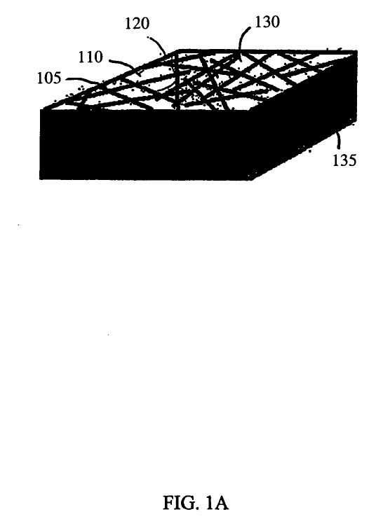

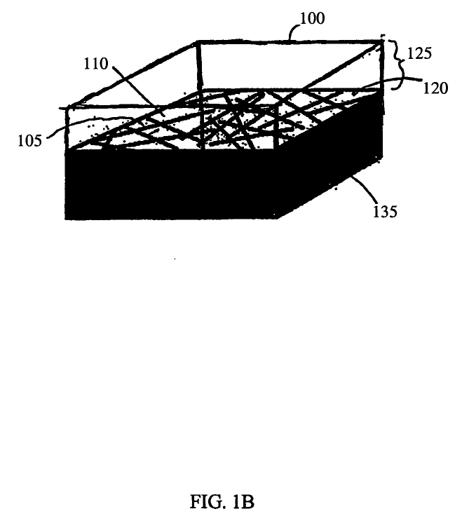

Referring to FIG. 1A, according to one embodiment of the invention, nanoink 120 consisting of nanomaterials 105 dispersed in a solvent 110 is placed on a substrate 135. Illustrative nanomaterials useful in the invention include, but are not limited to, organic and inorganic, single or multi-walled nanotubes, nanowires, nanodots, quantum dots, nanorods, nanocrystals, nanotetrapods, nanotripods, nanobipods, nanoparticles, nanosaws, nanosprings, nanoribbons, any branched nanostructure, and any mixture of these nanoshaped materials. These nanomaterials can be made of the following elements or compounds Au, Ag, Pt, Pd, Co, Ti, Mo, W, Mn, Cr, Fe, C, Si, Ge, B, Sn, SiGe, SiC, SiSn, GeC, BN, InP, InN, InAs, InSb, GaN, GaP, GaAs, GaSb, AlN, AlP, AlAs, AlSb, CdO, CdS, CdSe, CdTe, ZnO, ZnS, ZnSe, ZnTe, MgO, MgS, MgSe, MgTe, HgO, HgS, HgSe, HgTe, PbO, PbS, PbSe, PbTe, GeS, GeSe, GeTe, SnS, SnSe, SnTe, InO, SnO, SiOx, GeO, WO, TiO, FeO, MnO, CoO, NiO, CrO, VO, MSiO4 (M=Zn, Cr, Fe, Mn, Co, Ni, V, Ti), CuSn, CuF, CuCl, CuBr, Cul, AgF, AgCl, AgBr, AgI, CaCN2, BeSiN2, ZnGeP2, CdSnAs2, ZnSnSb2, CuGeP3, CuSi2P3, Si3N4, Ge3N4, Al2O3, Al2CO, or any combination thereof and any related alloys.

The nanomaterials may have a monocrystalline structure, a double-crystal structure, a polycrystalline structure, an amorphous structure, or a combination thereof.

The nanomaterials can also comprise: a metal, such as gold, nickel, palladium, iridium, cobalt, chromium, aluminum or titanium; a metal alloy; a polymer; a conductive polymer; a ceramic material; or any combination thereof.

When a nanomaterial comprises a semiconductive material, the semiconductive material may further comprise a dopant. Dopants useful in the present invention include, but are limited to: a p-type dopant, such as B, Al, In, Mg, Zn, Cd, Hg, C, Si, an element from Group II of the periodic table, an element from Group III of the periodic table or an element from Group IV of the periodic table; or an n-type dopant, such as, Si, Ge, Sn, S, Se, Te, P, As, Sb, or an element from group V of the periodic table.

The nanomaterials may be produced using any known methods, including, but not limited to, arc discharge, laser ablation, solution-based methods, vapor-phase methods or high-temperature substrate-based methods, such as those described in Baddour et al., Int. J Chem. Reactor Eng. 3, R3, (2005), and International Publication No. WO 02/017362.

Methods for making nanocrystals are described, for example, in Puntes et al., Science 291:2115-2117 (2001), U.S. Pat. No. 6,306,736 to Alivastos et al., U.S. Pat. No. 6,225,198 to Alivastos et al., U.S. Pat. No. 5,505,928 to Alivastos et al., U.S. Pat. No. 6,048,616 to Gallagher et al., and U.S. Pat. No. 5,990,479 to Weiss et al., each of which is incorporated herein by reference in its entirety.

Methods for making nanowires are described, for example, in Gudiksen et al., J. Am. Chem. Soc. 122:8801-8802 (2000), Gudkisen et al., Appl. Phys. Lett. 78:2214-2216 (2001), Gudiksen et al., J. Phys. Chem. B 105:4062-4064, Morales et al., Science 291:208-211 (1998), Duan et al., Adv. Mater. 12:298-302 (2000), Cui et al., J. Phys. Chem. B 105:5213-5216 (2000), Puentes et al., Science 291:2115-2117 (2001), Greene et al., Angew. Chem. Int. Ed. 42:3031-3034 (2003), Peng et al., Nature. 404:59-61 (2000), U.S. Pat. No. 6,306,736 to Alivastos et al., U.S. Pat. No. 6,225,198 to Alivastos et al., U.S. Pat. No. 6,036,774 to Lieber et al., U.S. Pat. No. 5,897,945 to Lieber et al. and U.S. Pat. No. 5,997,832 to Lieber et al., each of which is incorporated herein by reference in its entirety.

Methods for making nanoparticles are described, for example, in Liu et al., J. Am. Chem. Soc. 123:4344 (2001), U.S. Pat. No. 6,413,489 to Ying et al., U.S. Pat. No. 6,136,156 to El-Shall et al., U.S. Pat. No. 5,690,807 to Clark et al., each of which is incorporated herein by reference in its entirety.

Nanomaterials 105 may be dispersed within solvent 110 by, for example, ultrasonication. Further, larger nanomaterials and their aggregates may be removed or dispersed by, for example, centrifugation. Generally, nanomaterials 105 dispersed in solvent 110 is known as nanoink 120. Solvent 110 may be, for example, an organic solvent or water plus surfactant. Examples of suitable solvents include but are not limited to, γ-butyrolactone, N,N-dimethylformamide, dimethylacetamide, diethylacetamide, hexamethylphosphoramide, toluene, dimethylsulfoxide, cyclopentanone, tetramethylene sulfoxide, o-dichlorobenzene (DCB), ε-caprolactone, isopropyl alcohol (IPA), dimethylformamide (DMF), toluene, chloroform, xylene, N-methylprrolidone (NMP), nitromethane, acrylonitrile, 1-butanol, ethanol, ethyleneglycol, methanol, and combinations thereof. Examples of suitable surfactants include but are not limited to sodium dodecylbenzene sulfonate (SDBS), lithium dodecyl sulfate (LDS), sodium dodecyl sulfate (SDS), Triton-X and combinations thereof. The nanomaterials 105 may be randomly dispersed, evenly dispersed, or unevenly dispersed within solvent 110. Suitable materials for the substrate include, but are not limited to, iron, SiO₂, iron/SiO₂ gel; alumina; a silicate; a nitride, such as GaN, InN, AlN or Si₃N₄; quartz; glass; plastic; a semiconducting material such as silicon, germanium, tin, GaAs, InP, SiC or ZnSe; or an insulating material such as an acetate, a ceramic, an acrylic, beryllium oxide, fiberglass, a polyimide film, teflon, lexan, melamine, mica, neoprene, nomex, kapton, merlon, a polyolefin, a polyester, a polystyrene, a polyurethane, polyvinylchloride, or a thermoplastic. Prior to contact with nanoink 120, substrate 135 may be treated with a monolayer of a silane, for example, 3-aminopropyl triethoxysilane to improve the adhesion of nanomaterials to the substrate.

Referring to FIG. 1B, in some embodiments of the invention, the nanoink and substrate are contained within a housing 100. First substrate 135 is placed or formed in housing 100 and thereafter nanoink 120 may be applied on the substrate within housing 100. Typically, nanoink 120 does not completely fill housing 100 leaving a gap or space at the top of the housing 125.

Referring to FIG. 1A, in some embodiments of the invention, the nanoink is deposited on the substrate without a housing. Here, nanoink 120 may be applied on substrate 135 and other forces may prevent nanoink 120 from spilling off substrate 135. For example, substrate 135 may have a lip preventing nanoink 120 from spilling. In other instances, a physical force such as friction, cohesion, and adhesion may prevent nanoink 120 from spilling off substrate 135.

Substrate 135 has a planar surface 130, which has a two-dimensional shape. Planar surface 130 may be, but is not limited to being square, rectangular, circular, triangular, rhombus, polygonal, or any other suitable shape.

In some embodiments, rather than having planar surface 130 with a layer of nanoink, a line or a point of nanoink may be laid on planar surface 130. A line pattern may be a series of connecting points laid on planar surface 130. A line pattern may include straight patterns, for example, a straight line or non-straight patterns, for example, s-patterns. An inkjet printing technique may be used to create a line or point of nanoink 120 on substrate 135. An inkjet printing technique may use a standard printer cartridge to print nanoink 120 on substrate 135 where the input that normally receives ink is replaced with an input that receives nanoink. Further, other techniques may produce a line or point, for example, painting nanoink 120 on substrate 135. Dipping a brush like material into nanoink and applying it to substrate 135 may accomplish painting nanoink 120 on substrate 135. A brush like material may be for example, a toothpick, a painter's brush, a syringe, a tube, or any material that the nanoink temporarily adheres to. Also, printing or painting a series of small squares on substrate 135, which may connect with one another, can produce a pattern on planar surface 130.

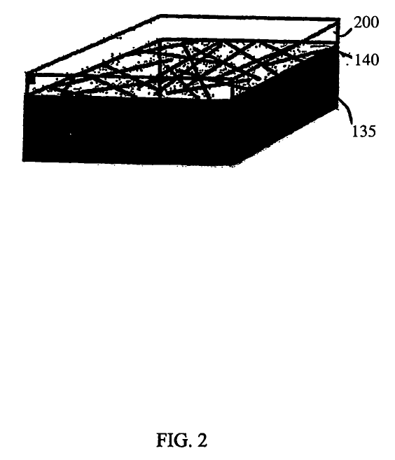

Referring to FIG. 2, when the user removes the solvent in the nanoink this leaves a nanolayer 140 consisting of nanomaterials. A material 200, which may be substantially fluidic, substantially solid, or a combination of both, is applied on top of the nanolayer 140 forming a second layer. If material 200 is substantially fluidic, it may be poured on nanolayer 140. If material 200 is substantially solid it may be laid on nanolayer 140. Preferably, material 200 is drop cast on nanolayer 140. Drop casting comprise, for example, pouring or dropping material 200 onto nanolayer 140. Material 200 may be a polymer or a small molecule material. Examples of polymers include but are not limited to polycarbonate, poly(methyl methacrylate), polystyrene, styrene methyl methacrylate, polyethylene terephthalate, polyester, polyvinyl chloride, polyimide, styrene acrylonitrile, acrylonitrile butadiene styrene and any combination of the listed polymers. These should preferably be mixed with a solvent. Preferably, material 200 is substantially transparent and flexible, and is in liquid form at room temperature.

In the illustrated embodiment, solvent may be removed from material 200. The solvent may be removed by, for example, baking, or by using another chemical/biological method. The removal of the solvent in material 200 may change material properties such as flexibility.

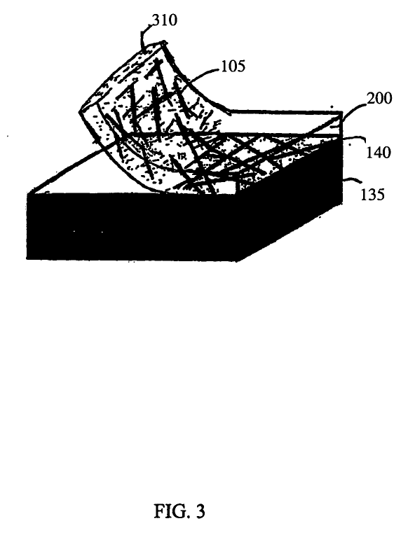

Referring to FIG. 3, material 200 and nanomaterials 105 may be peeled from substrate 135. Here, material 200 and nanomaterials 105 are substantially combined creating a material with nanomaterials adhered to the surface 310. Nanomaterials 105 adhere to material 200 because the work of adhesion between the nanomaterials 105 and the material 200 is greater than the work of adhesion between the nanomaterials 105 and substrate 135. As shown, nanomaterials adhere along one side of material 310. Nanomaterials 105 may define a uniform, highly inter-connected network of nanomaterials. The density of nanomaterials on material 310 may be dependent upon the concentration of nanomaterials 105 in nanoink 120 and the immersion time of material 200 in nanoink 120. Peeling may be, for example, pulling material 200 and nanomaterials 105 from substrate 135 or shearing material 200 and nanomaterials 105 from substrate 135. The nanomaterials 105 typically remain substantially in the surface of material 200, however, nanomaterials 105 may remain embedded within the surface of material 200 to a depth less than 200 nm.

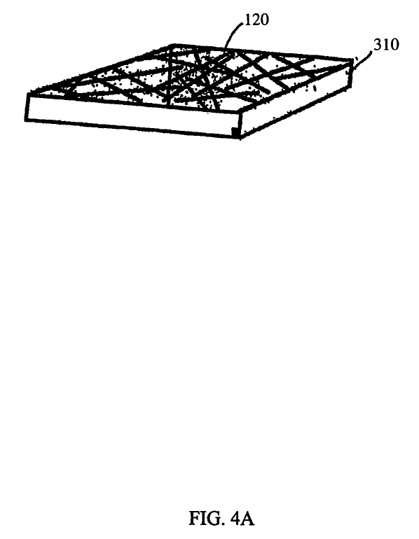

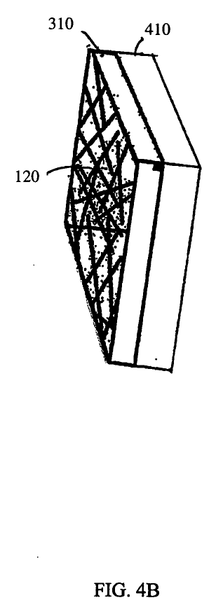

Referring to FIG. 4A, as shown, material 310 may be completely peeled from substrate 135. In this instance, material 310 may be used for products that require electrical conductivity along a surface. Conductive nanomaterials adhered to the surface of a material may conduct electricity along that surface, for example, the surface conductance may be greater than 0.001 siemens/square. Also, semi-conductive nanomaterials adhered to the surface of a flexible material may be used for other means. The material with nanomaterials embedded in the surface may be substantially transparent, for example, the optical transmittance may be greater than 80%.

Referring to FIG. 4B, in some embodiments, prior to or after peeling material 310 from substrate 135, an additional material 410 may be applied on material 310. Here, this additional material may be applied to improve mechanical properties, for example, rigidity, flexibility, stiffness, durability, or any other mechanical property. Further, another material may be applied to improve electrical properties, for example, insulation. The material applied may be a substantially similar material or substantially different material than material 310. Normally, the material is applied to a surface where nanomaterials are not exposed. Also, the material applied may cover the entire surface or only at specific location on material 310.

Further referring to FIG. 2, material 200 may remain on top of nanolayer 140 to protect or store the nanolayer 140. This may be desired because the nanomaterials may be sensitive to the surrounding environment. As an example, exposing conductive nanomaterials to air may cause them to oxidize. Here, material 200 may remain on nanolayer 140 until using nanomaterials 105 is desired. When desired, material 200 may be dissolved away from nanolayer 140 in the method previously described.

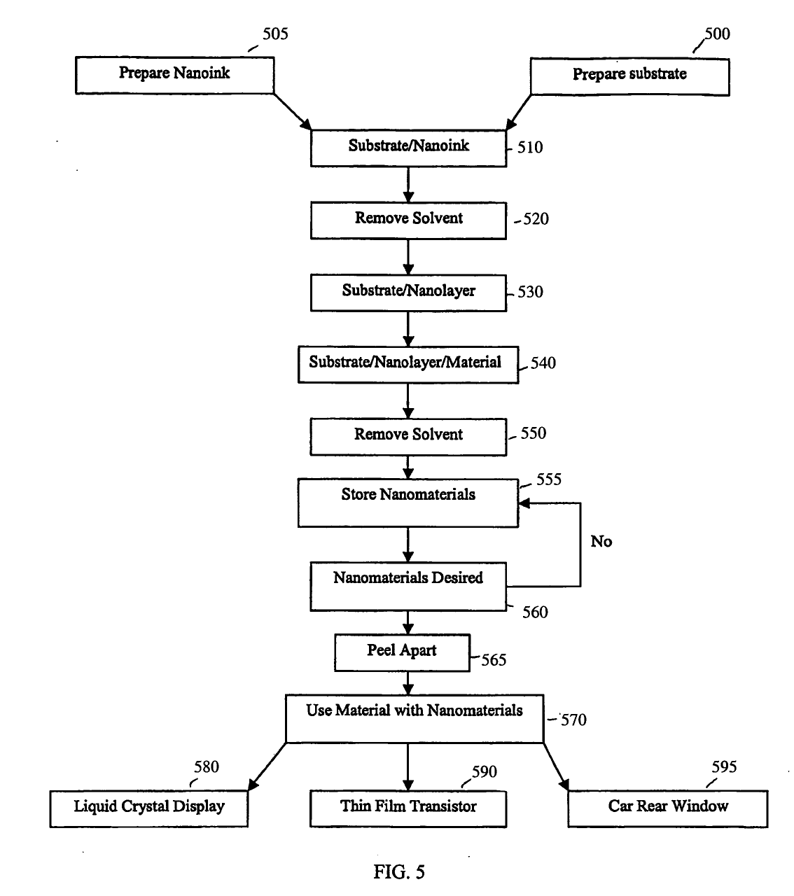

Referring to FIG. 5, a general process for creating and using a material with nanomaterials attached to the surface is illustrated. Initially, the material with nanomaterials may be created. The user prepares the nanoink at step 505 and the substrate at step 500. The nanoink may then be applied on substrate at step 510 and the solvent removed at step 520 forming a nanolayer consisting of nanomaterials adhered to the substrate at step 530. The material layer may then be added onto the nanolayer at step 540 forming a second layer after removing solvent at step 550. Here, the user may decide to store the nanomaterials at step 555 for later use. If the material with nanomaterials attached is desired at step 560, the material with nanomaterials attached at the surface may be peeled from the substrate at step 565. The material may now be ready for use at step 570. If the nanomaterials were stored at step 555, the nanomaterials remain protected. The material may now be ready for use at step 570. As an example, the material may be used in a liquid crystal display at step 580, a thin film transistor at step 590, or a car rear window at step 595.

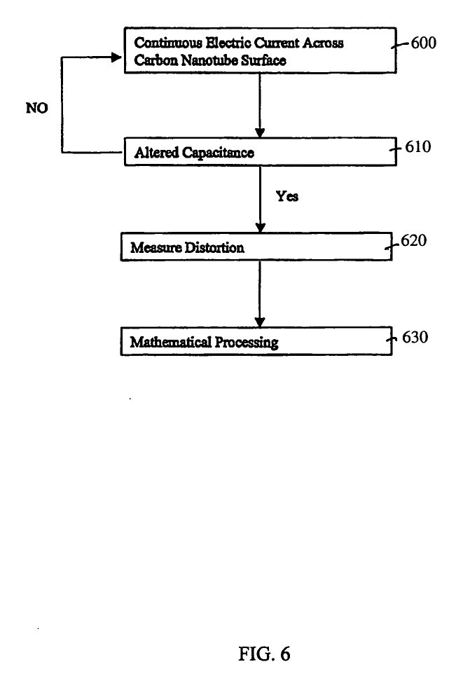

Referring to FIG. 6, an illustration of one use for a material with nanomaterials attached at the surface is outlined. Here, the general process may be used in capacitive touch screens such as liquid crystal displays or thin film transistors. Presently, capacitive touch screens use ITO on their external surfaces. The present invention replaces the capacitive touch screens with ITO with transparent materials with nanomaterials attached on the surface. In this example, the nanomaterials may be attached to the external surface of the touch screen. In use, a continuous electric current may cross the nanomaterials' surface at step 600. When a user touches the screen, there may be an altered capacitance at step 610. When an altered capacitance occurs, the distortion may be measured at step 620. After the distortion is measured, a computer runs a mathematical process at step 630 determining the location of the touch and the appropriate response.

It is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Although the present invention has been described and illustrated in the foregoing exemplary embodiments, it is understood that the present disclosure has been made only by way of example, and that numerous changes in the details of implementation of the invention may be made without departing from the spirit and scope of the invention, which is limited only by the claims which follow.

What is claimed is:

1. A method for producing a material with nanomaterials attached, comprising:
applying a nanoink on a substrate to form a first layer, the nanoink comprising nanomaterials and a first solvent;
removing the solvent from the nanoink thus obtaining a nanolayer consisting of nanomaterials adhered to the substrate
applying a material layer on the nanolayer to form a second layer, the material layer comprising a material and a second solvent;
removing at least some of the solvent from the second layer; and
peeling the second layer from the substrate whereby the nanolayer adheres to the second layer.

2. The method of claim 1 wherein the peeled second layer is transparent and flexible.

3. The method of claim 1 further comprising applying the material layer on the nanolayer at room temperature.

4. The method of claim 1 further comprising selecting the first solvent in the nanoink from a group comprising an organic solvent and water plus a surfactant.

5. The method of claim 1 wherein the substrate is selected from a group comprising organic and inorganic materials

6. The method of claim 5 further comprising treating the substrate with a monolayer of silane prior to the applying of the nanoink.

7. The method of claim 1 wherein a surface of the peeled second layer is one of square, rectangular, circular, triangular, rhombus, polygonal, linear, and a point in shape.

8. The method of claim 1 wherein the material is one of a polymer and a small molecule material.

9. The method of claim 1 further comprising applying an additional material layer to the second layer for enhancing physical properties of the second layer.

10. The method of claim 1 wherein the applying of the material layer comprises drop casting the material layer onto the nanolayer.

11. The method of claim 1 wherein the peeling of the second layer from the substrate comprises one of pulling and shearing the second layer from the substrate.

12. The method of claim 1 wherein the removing of the at least some solvent comprises baking the second layer.

13. The method of claim 12 further comprising peeling the second layer from the substrate whereby the nanolayer adheres to the second layer

14. A product having a selective electrically conducting surface comprising:
a transparent material with at least one planar surface; and
a layer of nanomaterials embedded in one planar surface of the material.

15. The product of claim 14 wherein the planar surface of the material is square, rectangular, circular, triangular, rhombus, polygonal, linear, or a point in shape.

16. The product of claim 14 wherein a second transparent material is adhered to the transparent material.

17. The product of claim 14 wherein the nanomaterials are electrically conductive or semi-conductive.

18. The product of claim 14 wherein the nanomaterials are uniformly dispersed and highly interconnected when embedded in the planar surface of the material.

19. The product of claim 14 wherein the planar surface with nanomaterials has a surface conductance greater than 0.001 siemens/square.

20. The product of claim 14 wherein the transparent material with nanomaterials embedded in the at least one planar surface has an optical transmittance greater than 80%.

21. The product of claim 14, wherein the depth of nanomaterials embedded in one planar surface of the material is less than 200 nm.
